(19) United States
(12) Patent Application Publication
(10) Pub. No.: US 2017/0252973 A1
(43) Pub. Date: Sep. 7, 2017

(54) Methods for Controlling Warpage of Cavities of Three-Dimensionally Printed Articles During Heat Treament

(71) Applicant: The ExOne Company, North Huntingdon, PA (US)

(72) Inventors: Richard D. Clark, Mt. Pleasant, PA (US); Douglas P. Tuk, Latrobe, PA (US); Thomas G. Pasterik, Zelienople, PA (US); Brandon Cary, Zelienople, PA (US); Thomas Lizzi, Harmony, PA (US)

(21) Appl. No.: 15/517,837

(22) PCT Filed: Oct. 15, 2015
(86) PCT No.: PCT/US2015/055644

§ 371 Date: Apr. 7, 2017

Related U.S. Application Data
(60) Provisional application No. 62/064,045, filed on Oct. 15, 2014.

(51) Int. Cl. B29C 67/00; B22F 3/105; B22F 3/00; B22F 5/10; B28B 1/00

(52) U.S. Cl. CPC B29C 67/0077; B22F 5/106; B28B 1/001; B22F 3/008; B22F 3/1055; B29C 67/0051; B22F 5/10; B33Y 80/00

(57) ABSTRACT

Methods are presented for controlling warpage during heat treatment of a 3DPBJ article having a cavity extending inwardly from an outside surface wherein a 3DPBJ article is 3DPBJ printed from a build powder as is a 3DPBJ object which is adap ted to be contactingly insertable into the cavity of the 3DP BJ article. At least a portion of the 3DPBJ article cavity surface and/or at least a portion of the surface of the 3DPBJ object is treated to prevent the 3DPBJ object from becoming bonded to the 3DPBJ article during the heat treatment. The 3DPBJ object is inserted into the 3DPBJ article cavity and the 3DPBJ article and the 3DPBJ object are heat treated to transform the 3DPBJ article into the intended article itself and the 3DPBJ object into a heat treated 3DPBJ object. The heat treated 3DPBJ object is removed from the article.

### BACKGROUND

Field of the Invention

The present invention relates to methods for controlling warpage of cavities of three-dimensionally printed articles during heat treatment wherein the cavities extend inwardly from a surface of the article.

Background of the Art

One three-dimensional printing process that is particularly attractive for making complex geometry articles is the three-dimensional binder jet printing process. This process is also sometimes called the “three-dimensional inkjet printing process” because the binder jetting is done using a print head that resembles those developed for inkjet printing. For conciseness, the term “3DP BJ process” will be used hereinafter to refer to the three-dimensional printing binder jetting process, the printed article made by the 3DP BJ process will be referred to hereinafter as a “3DP BJ article”, and using the 3DP BJ process to make a 3DP BJ article will be referred to hereinafter as “3DP BJ printing” the article. For example, creating a binder-bonded particle version of a rotor using the 3DP BJ process would be referred to herein as “3DP BJ printing a 3DP BJ rotor”. A 3DP BJ article is in many instances heat treated to transform the 3DP BJ article into the intended article itself This transformation is accompanied by a marked increase in strength.

For economic reasons, it is desirable to use the 3DP BJ process to make articles having one or more cavities that extend inwardly from a surface of the article. Such cavities may terminate within the article, i.e. be a blind cavity, or may extend through the article to another surface of the article and/or may join with other such cavities. In many instances, such cavities are defined by one or more walls—whether called sidewalls, roofs, or floors—which may have thicknesses which are relatively thin compared to their spans. Since the structural features of a 3DP BJ article are weak relative what they are after heat treatment, i.e. the article itself, some cavities (or equivalently, their walls) are susceptible to gravity-induced geometrical distortion during the heat treatment. Such geometrical distortion is sometimes referred to in the art as “slumping” or “slumping warpage” and will be referred to hereinafter simply as “warpage”. In some instances, the occurrence of such warpage may disqualify the use of the 3DP BJ process from making an article. Accordingly, there is a need in the art to avoid such warpage from occurring.

### SUMMARY OF THE INVENTION

The present invention ameliorates the aforementioned warpage problem by providing methods for making an article having a cavity extending inwardly from an outside surface by 3DP BJ printing and subsequent heat treatment. According to these methods, a 3DP BJ article is 3DP BJ printed from a build powder as is a 3DP BJ object which is adapted to be contactingly insertable into the cavity of the 3DP BJ article. The term “contactingly insertable” is to be construed to mean that at least a portion of the 3DP BJ object can be inserted into the cavity of the 3DP BJ article in such a way that at least opposing portions of the outer surface of the 3DP BJ object contact at least opposing portions of the surface of the cavity in a manner which provides structural support for the higher of the contacted walls of the 3DP BJ article cavity from warpage during the heat treatment. Also according to these methods, at least a portion of the 3DP BJ article cavity surface and or at least a portion of the surface of the 3DP BJ object is treated to prevent the 3DP BJ object from becoming bonded to the 3DP BJ article during the heat treatment. Also according to these methods, the 3DP BJ object is inserted into the 3DP BJ article cavity and the 3DP BJ article and the 3DP BJ object are heat treated. The heat treatment transforms the 3DP BJ article into the intended article itself and the 3DP BJ object into a heat treated 3DP BJ object. According to these methods, the heat treated 3DP BJ object subsequently is removed from the article, i.e. it is removed from the cavity of the article.

Some embodiments of the present invention also include 3DP BJ printing a body that has a surface that mates with a surface of the 3DP BJ article and then treating at least one of these mating surfaces to prevent the 3DP BJ body from bonding to the 3DP BJ article during heat treatment. In such embodiments, at least a portion of the mating surface of the 3DP BJ article is supported by a corresponding portion of the mating surface of the 3DP BJ body during the heat treatment.

### BRIEF DESCRIPTION OF THE DRAWINGS

The criticality of the features and merits of the present invention will be better understood by reference to the attached drawings. It is to be understood, however, that the drawings are designed for the purpose of illustration only and not as a definition of the limits of the present invention.

FIG. 1 is a schematic perspective view of a 3DP BJ article having a cavity and two insertable objects in accordance with an embodiment.

FIG. 2 is a schematic perspective view of the article and the two insertable objects of FIG. 1 after the two insertable objects have been contactingly inserted into the cavity.

FIG. 3 is schematic perspective view of (a) another 3DP BJ article having a plurality of cavities, (b) an insertable object, and (c) two supports according to an embodiment.

FIG. 4 is a schematic side view of the 3DP BJ article of FIG. 3.

FIG. 5 is a schematic perspective view of the 3DP BJ article, the insertable object, and the supports of FIG. 3 after the insertable object has been contactingly inserted into one of the cavities of the article and the bottom surface of article has been placed in supporting contact with the top surfaces of the two supports.

FIG. 6 is a schematic perspective view of a second rectangular insertable object having a plurality of orifices which are adapted to permit the through flow of a flowable support powder.

### DESCRIPTION OF PREFERRED EMBODIMENTS

In this section, some preferred embodiments of the present invention are described in detail sufficient for one skilled in the art to practice the present invention without undue experimentation. It is to be understood, however, that the fact that a limited number of preferred embodiments are described herein does not in any way limit the scope of the present invention as set forth in the claims. It is to be understood that whenever a range of values is described herein or in the claims that the range includes the end points and every point therebetween as if each and every such point had been expressly described. Unless otherwise stated, the word “about” as used herein and in the claims is to be construed as meaning the normal measuring and/or fabrication limitations related to the value which the word “about” modifies. Unless expressly stated otherwise, the term “embodiment” is used herein to mean an embodiment of the present invention.

It is to be understood that it is within the scope of the present invention that the embodiments of the methods described herein may be used to make a single article or to make multiple articles at the same time. However, for simplicity sake, the descriptions of the preferred embodiments below reference only the making of a single article.

It is to be understood that the reference to an article having a cavity does not restrict the present invention to use with articles having only a single cavity extending inwardly from an outside surface. The present invention embraces articles having one or more cavities and the cavities may the same as or different from each other and the cavities may interjoin. It is also to be understood that any such cavity may be a through-cavity or blind cavity.

It is to be understood that the term “powder” herein is also sometimes referred to in the art as “particulate material” or “particles” and the term “powder” is to be construed herein as meaning any such material, by whatever name, that is used in the 3DP BJ process as a layer-forming material upon which a binder is deposited for the creation of the desired article. The powder may comprise any type of material capable of taking on the powder form, e.g. metal, plastics, ceramics, carbon, graphite, composite materials, minerals, etc.

It is also to be understood that the present invention may be used with any type of article having a cavity extending inwardly from an exterior surface.

The basic 3DP BJ process was developed in the 1990's at the Massachusetts Institute of Technology and is described in several United States patents, including the following U.S. Pat. No.: 5,490,882 to Sachs et al., U.S. Pat. No. 5,490,962 to Cima et al., U.S. Pat. No. 5,518,680 to Cima et al., U.S. Pat. No. 5,660,621 to Bredt et al., U.S. Pat. No. 5,775,402 to Sachs et al., U.S. Pat. No. 5,807,437 to Sachs et al., U.S. Pat. No. 5,814,161 to Sachs et al., U.S. Pat. No. 5,851,465 to Bredt, U.S. Pat. No. 5,869,170 to Cima et al., U.S. Pat. No. 5,940,674 to Sachs et al., U.S. Pat. No. 6,036,777 to Sachs et al., U.S. Pat. No. 6,070,973 to Sachs et al., U.S. Pat. No. 6,109,332 to Sachs et al., U.S. Pat. No. 6,112,804 to Sachs et al., U.S. Pat. No. 6,139,574 to Vacanti et al., U.S. Pat. No. 6,146,567 to Sachs et al., U.S. Pat. No. 6,176,874 to Vacanti et al., U.S. Pat. No. 6,197,575 to Griffith et al., U.S. Pat. No. 6,280,771 to Monkhouse et al., U.S. Pat. No. 6,354,361 to Sachs et al., U.S. Pat. No. 6,397,722 to Sachs et al., U.S. Pat. No. 6,454,811 to Sherwood et al., U.S. Pat. No. 6,471,992 to Yoo et al., U.S. Pat. No. 6,508,980 to Sachs et al., U.S. Pat. No. 6,514,518 to Monkhouse et al., U.S. Pat. No. 6,530,958 to Cima et al., U.S. Pat. No. 6,596,224 to Sachs et al., U.S. Pat. No. 6,629,559 to Sachs et al., U.S. Pat. No. 6,945,638 to Teung et al., U.S. Pat. No. 7,077,334 to Sachs et al., U.S. Pat. No. 7,250,134 to Sachs et al., U.S. Pat. No. 7,276,252 to Payumo et al., U.S. Pat. No. 7,300,668 to Pryce et al., U.S. Pat. No. 7,815,826 to Serdy et al., U.S. Pat. No. 7,820,201 to Pryce et al., U.S. Pat. No. 7,875,290 to Payumo et al., U.S. Pat. No. 7,931,914 to Pryce et al., U.S. Pat. No. 8,088,415 to Wang et al., U.S. Pat. No. 8,211,226 to Bredt et al., and U.S. Pat. No. 8,465,777 to Wang et al.

In essence, the 3DP BJ process involves the spreading of a layer of a powder and then selectively inkj et-printing a fluid onto that layer to cause selected portions of the powder layer to bind together. This sequence is repeated for additional layers until the desired article has been constructed. The material making up the powder layer is often referred as the “build material” or the “build material powder” and the jetted fluid is often referred to as a “binder”, or in some cases, an “activator”. During the 3DP BJ process, the portions of the powder layers which are not bonded together with the binder form a bed of supporting powder around the article or articles which are being made, i.e. a “build material powder bed.”

Heat treating of a 3DP BJ article is sometimes required in order to strengthen and/or densify the 3DP BJ article. Often, the first portion of the heat treatment will be to heat the 3DP BJ article while it is still supported by the powder bed in order to cure the binder. The first portion is followed by removing the 3DP BJ article from the powder bed and a second portion of the heat treatment may include heating the 3DP BJ article to temperatures sufficient to sinter together the powder of the 3DP BJ article. For example, when metal powders are used as the build material, the post-processing sometimes involves sintering the metal powder together and/or infiltrating the sintered, but porous article, with a molten metal, e.g. through infiltration stem 26 on adapter 2 (see FIG. 2).

In embodiments, a 3DP BJ article is 3DP BJ printed from a build powder as is a 3DP BJ object which is adapted to be contactingly insertable into the cavity of the 3DP BJ article. At least a portion of the 3DP BJ article cavity surface and or at least a portion of the surface of the 3DP BJ object is treated to prevent the 3DP BJ object from becoming bonded to the 3DP BJ article during the heat treatment. The 3DP BJ object is contactingly inserted into the 3DP BJ article cavity and the 3DP BJ article and the 3DP BJ object are heat treated. The 3DP BJ article is supported by a powder bed during the heat treatment. The heat treatment transforms the 3DP BJ article into the intended article itself and the 3DP BJ object into a heat treated 3DP BJ object, which is then removed from the cavity of the article.

The advantage of the use of an inserted 3DP BJ object to provide support during heat treatment over the use a rigid insertable object is that the 3DP BJ object's surfaces move and the 3DP BJ object shrinks during the heat treatment in a manner that is very similar to that of the 3DP BJ article surfaces which it contacts and the cavity into which it is inserted. In contrast, a rigid insertable object, even if initially, intermediately, or finally fitting the cavity, would not move along with the 3DP BJ article surface in the manner that the 3DP BJ body surface does or shrink as the cavity does.

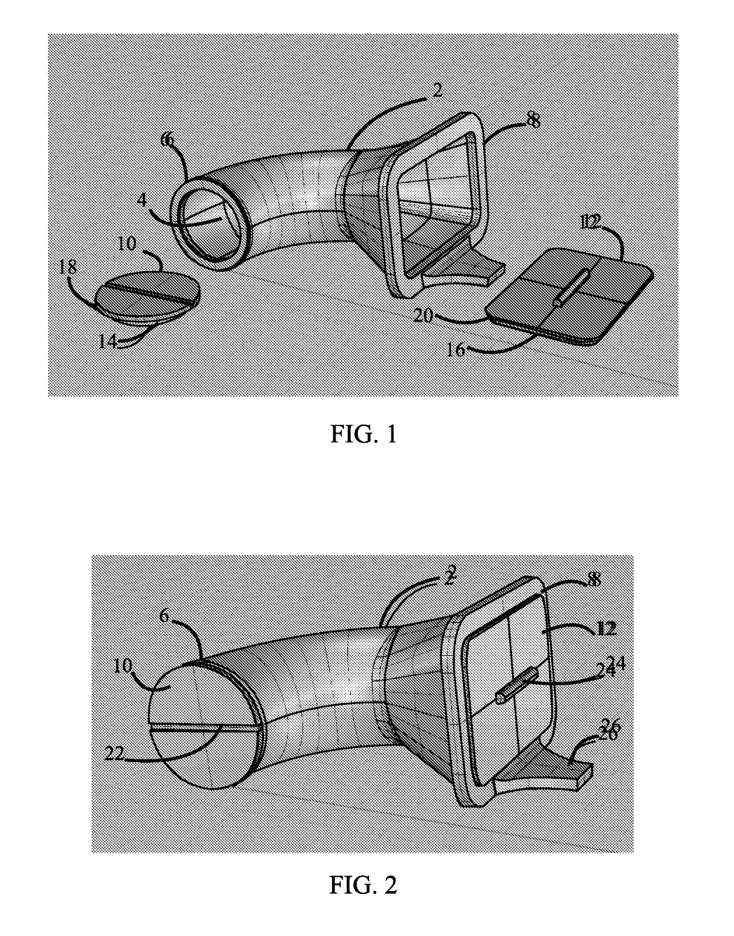

A first preferred embodiment will now be described with reference to FIGS. 1 and 2. FIG. 1 is a schematic perspective view of a 3DP BJ article, i.e. a 3DP BJ flow channel elbow adaptor 2. The adapter 2 has a continuous cavity 4 extending inwardly from the round end 6 of the adaptor 2 and from the rectangular end 8 of the adaptor 2. FIG. 1 also shows a perspective view of a 3DP BJ round object 10 which is adapted to be contactingly insertable into the cavity 4 at the round end 6 and a 3DP BJ rectangular object 12 which is adapted to be contactingly insertable into the cavity 4 at the rectangular end 8. The round object 10 and the rectangular object 12 are made from the same build powder as the adapter 2. Note that the round object 10 and the rectangular object 12 each have a necked portion, i.e. the round neck 14 and the rectangular neck 16 respectively, which are adapted to be contactingly insertable into the cavity 4 at the respective round end 6 and the rectangular end 8. Also note that the round object 10 and the rectangular object 12 each have rim portions, i.e. the round rim 18 and the rectangular rim 20 respectively, which are adapted remain outside of the cavity 4.

FIG. 2 is a schematic perspective view of the adapter 2 after the round object 10 has been contactingly inserted into the cavity 4 (not visible) at the round end 6 and the rectangular object 12 has been contactingly inserted into the cavity 4 at the rectangular end 8. Note that the round object 10 has a groove 22 which may be used to insert a tool to aid in the placement into and/or removal of the round object 10 from the cavity 4. Likewise, rectangular object 12 has a handle 24 which may be used to aid in the placement into and/or the removal of the rectangular object 12 from the cavity 4.

It is to be understood that although the round and rectangular necks 14, 16 are shown in FIG. 1 to be insertable only a short way into the cavity 4, it is within the scope of the present invention for the portion of the object that is to be contactingly insertable into the cavity of the article to extend into the article's cavity to any desired depth to prevent warpage from occurring during heat treatment. In some instances, the geometry of the cavity will limit the depth to which an object can extend into the cavity. In any instance, the depth to which the object extends into the cavity is a matter of design choice based upon the warpage expected if the object was not used.

Prior to contactingly inserting the round and rectangular bodies 10, 12 into the cavity 4, at least a portion of the surface of the cavity 4 and/or at least a portion of the surface of each of the round and the rectangular bodies 10, 12 are treated to prevent the round and the rectangular bodies 10, 12 from bonding to the adapter 2 during the heat treatment. In some embodiments, the treating includes coating the selected surface with an interface material, e.g. boron nitride, which prevents interdiffusion or reaction between the object and the article. In some embodiments, the treating includes applying a material, e.g. a reducing or oxidizing material, to the selected surface that will cause the surface itself to become relatively inert to interdiffusion or reaction between the object and the article. When applying an interface material that is in the form of a fine powder, e.g. boron nitride, is helpful to suspend the interface material in an evaporable liquid and then paint the suspension onto the surface that is to be coated. When such a suspension is used, it is also helpful to heat the surface to a temperature that is near or above the normal boiling point of the evaporable liquid as a caution against the liquid infiltrating into the 3DP BJ article, body, or object.

As mentioned above, the 3DP BJ article is supported by a powder bed during heat treatment. The powder bed may comprise any powder which is capable of providing support to the 3DP BJ article and which will remain flowable throughout the heat treatment so that it can be removed from the article after heat treatment has been completed. It is preferable that the powder bed powder does not react with the 3DP BJ article during the heat treatment, although a small amount of reaction may be tolerable in some instances, especially on surfaces of the article which are to be subsequently sand blasted, machined, abrasion cleaned, and/or chemically cleaned. When the heat treatment includes an initial stage of curing the binder, the powder bed is preferably the build material powder bed and the cured 3DP BJ article is removed from the build material powder bed afterward for further heat treatment in another power bed.

The powder bed preferably fills cavities of the 3DP BJ article, including the cavity into which an insertable object is inserted. In some embodiments, it is preferred to provide a reservoir of powder above an entrance to a cavity so that the support powder can flow into the cavity during any settling that may occur during the heat treatment. In embodiments in which all of the ends of a cavity are closed off, e.g. as shown in the embodiment in FIG. 2, it is preferred that the support powder loosely fill the cavity since a dense packing of the enclosed support powder may undesirably restrict the shrinkage of the cavity during the heat treatment.

It is also within the scope of the present invention to provide one or more orifices in the insertable objects to allow for flow of the support powder therethrough. Such orifices are to be dimensioned and located so that they do not compromise the supporting function of the insertable object which is necessary for cavity warpage control. Referring to FIG. 6, there is shown a 3DP BJ second rectangular object 60 which is designed to be a replacement for the rectangular object 12 that is shown in FIGS. 1 and 2. The second rectangular object 60 has a plurality of orifices, e.g. orifices 62, 64, 66, 68, which are adapted to permit support powder through the second rectangular object 60 after it has been inserted into cavity 4 (refer to FIG. 1) while not compromising the support function of the second rectangular object 60.

In some embodiments, the resistance to warpage is improved upon by supporting one or more exterior surfaces of the 3DP BJ article with the mating surface or mating surfaces of one or more 3DP bodies. Such embodiments include 3DP BJ printing a body that has a surface that mates with a surface of the 3DP BJ article and then treating at least one of these mating surfaces to prevent the 3DP BJ body from bonding to the 3DP BJ article during heat treatment. During the heat treatment of the 3DP BJ article, at least a portion of the mating surface of the 3DP BJ article is supported by a corresponding portion of the mating surface of the 3DP BJ body. This manner of supporting the 3DP BJ article surface on a mating 3DP BJ body surface provides more rigid support to the 3DP BJ article than can be provided by a flowable powder bed. The advantage of this manner of support over providing support on a rigid surface is that the 3DP BJ body surface moves during the heat treatment in a manner that is very similar to that of the mating 3DP BJ article whereas a rigid surface, even if initially, intermediately, or finally matching, would not move along with the 3DP BJ article surface in the heat treatment compensating manner that the 3DP BJ body surface does.

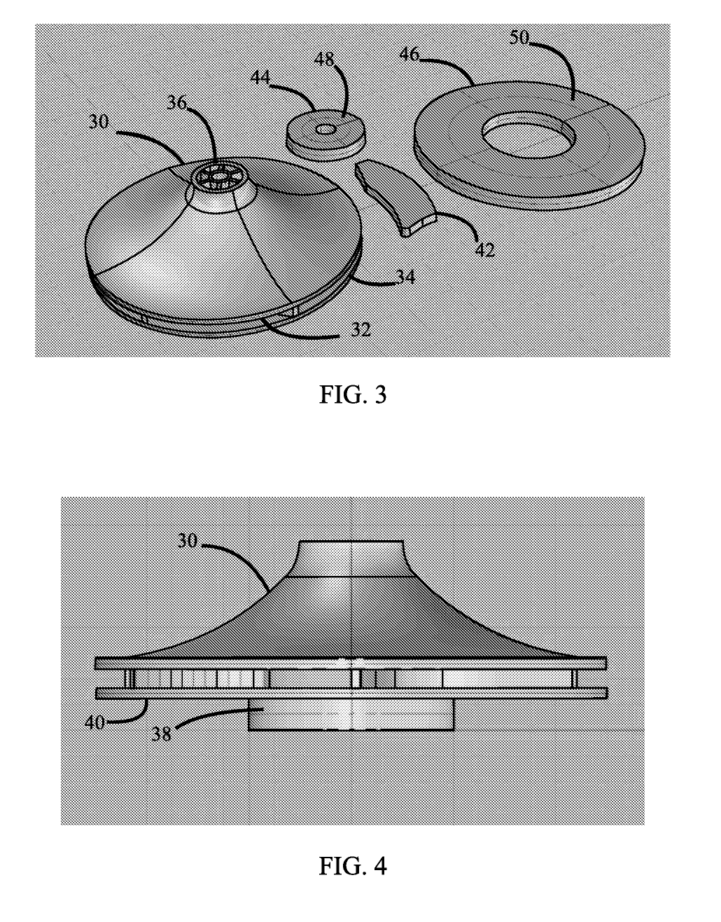

An example of such an embodiment will now be described. FIGS. 3 and 4, respectively, are schematic perspective and side views of another 3DP BJ article, i.e. a 3DP BJ enclosed vane rotor 30. The rotor 30 has a plurality of vane cavities, e.g. vane cavity 32, which extends inwardly from the radial peripheral surface 34 of the rotor 30. Each of vane cavities extends through the rotor 30 to the open top end 36 of the rotor 30. The rotor 30 also has a hollow collar 38, which extends downwardly from the bottom surface 40 of the rotor 30 so that a portion of the bottom surface 40 is enclosed by the collar 38.

FIG. 3, in addition to showing the rotor 30, shows a 3DP BJ insertable object 42, which is contactingly insertable into the vane cavity 32, a 3DP BJ center support 44, and a 3DP BJ bottom support 46, all of which are made from the same build powder as the rotor 30. For simplicity, only one 3DP BJ insertable object 42 is shown, but similar insertable objects may be provided for each of the other vane cavities of the vane 30.

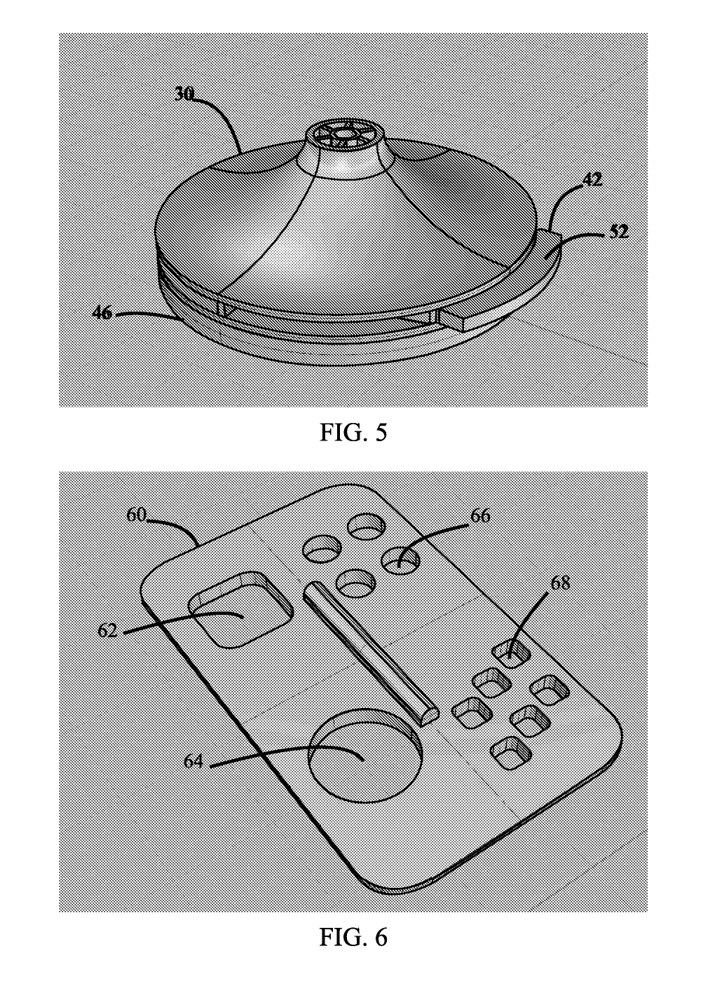

The top surfaces 48, 50 of the center support 44 and the bottom support, respectively, are adapted to mate with the respective areas of the bottom surface 40 of the rotor 30 which they are adapted to support during at least a part of the heat treatment of the rotor 30. Referring now to FIG. 5, there is shown a schematic perspective view of the rotor 30. The insertable object 42 has been contactingly inserted into the vane cavity 32 (not visible due to the insertion of insertable object 42 thereinto) and the center support 44 (not visible) and the bottom support 46 have been put into place under the rotor 30 with their respective top surfaces 48, 50 (not visible) in supporting contact with the bottom surface 40 (not visible) of the rotor 30. A handle portion 52 of the insertable 42 object extends out of the rotor 30 to aid in the placement of the insertable object 42 in and its withdrawal from the rotor 30. The rotor 30 is supported on its bottom surface 40 (not visible) by the top surfaces 48, 50 (not visible), respectively, of the center support 44 (not visible) and the bottom support 46. The center support 44 (not visible) is located within the collar 38 (not visible).

While only a few embodiments of the present invention have been shown and described, it will be obvious to those skilled in the art that many changes and modifications may be made thereunto without departing from the spirit and scope of the invention as described in the claims. All United States patents and patent applications, all foreign patents and patent applications, and all other documents identified herein are incorporated herein by reference as if set forth in full herein to the full extent permitted under the law.

What is claimed is:

1. A method for making an article having a cavity extending inwardly from an outside surface, the method comprising the steps of:
a) 3DP BJ printing a 3DP BJ article from a build material, wherein the 3DP BJ article is a 3DP BJ version of the article;
b) 3DP BJ printing from the build material a 3DP BJ object which is adapted to be contactingly insertable into the cavity of the 3DP BJ article;
c) treating at least one of at least a portion the surface of the cavity and at least a portion of the surface of the 3DP BJ object to prevent the 3DP BJ object from becoming bonded to the 3DP BJ article during step (e) hereof;
d) inserting the 3DP BJ object into the 3DP BJ article cavity;
e) heat treating the 3DP BJ article and 3DP BJ object to transform the 3DP BJ article and the 3DP BJ object into, respectively, the article and a heat treated 3DP BJ object; and
f) removing the heat treated 3DP BJ object from the article.

2. The method of claim 1, wherein the build material is a metal powder.

3. The method of claim 1, wherein the build material is a ceramic powder.

4. The method of claim 1, wherein the build material comprises at least one selected from the group of a carbon powder and a graphite powder.

5. The method of claim 1, wherein the step of heat treating includes sintering the 3DP BJ article.

6. The method of claim 1, wherein the step of heat treating includes infiltrating the 3DP BJ article with a solidifiable liquid material.

7. The method of claim 6, wherein the solidfiable liquid material is solid at normal use temperatures of the article.

8. The method of claim 1, wherein step (c) hereof includes coating the 3DP BJ object with a coating material, the coating material being adapted to prevent the 3DP BJ object from becoming bonded to the 3DP BJ article during step (e) hereof.

9. The method of claim 8, wherein the coating material comprises boron nitride.

10. The method of claim 1, wherein the article is an enclosed vane rotor.

11. The method of claim 1, further comprising the steps of:
(g) 3DP BJ printing from the build material a 3DP BJ body having a first surface which mates with a first surface of the 3DP BJ article;
(h) treating at least one of the respective first surfaces of the 3DP BJ body and the 3DP BJ article to prevent the 3DP BJ body from becoming bonded to the 3DP BJ article during step (e) hereof; and
(i) at least partially supporting the first surface of 3DP BJ article upon the first surface of the body during step (e) hereof.

12. The method of claim 11, wherein step (h) hereof includes coating the 3DP BJ object with a coating material, the coating material being adapted to prevent the 3DP BJ object from becoming bonded to the 3DP BJ object during step (e) hereof.

13. The method of claim 1, wherein the 3DP BJ object has a handle portion which extends outside of the 3DP BJ article cavity when the 3DP BJ object has been inserted into the 3DP BJ article cavity.

14. The method of claim 1, further comprising supporting the 3DP BJ article in a powder bed during step (e) hereof, wherein the powder bed comprises a flowable powder and the 3DP BJ object has an orifice adapted to permit flow of the powder through the 3DP BJ object.
